(19) United States
(12) Patent Application Publication
(10) Pub. No.: US 2004/0201771 A1
(43) Pub. Date: Oct. 14, 2004

(54) Image-taking apparatus and image-taking method

(75) Inventor: Daisuke Itoh, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/819,124

(22) Filed: Apr. 7, 2004

(30) Foreign Application Priority Data
Apr. 14, 2003 (JP) 2003-109084

(51) Int. Cl. H04N 5/238

(52) U.S. Cl. 348/363

(57) ABSTRACT

An aperture diameter of a variable diaphragm, which includes six diaphragm blades, is changed during an exposure. When image-taking operation is carried out, the variable diaphragm is set in a small aperture setting in which an f-number is one step larger than a proper aperture setting which is calculated by metering light. The variable diaphragm is driven from a small aperture position, and increases the aperture diameter gradually. The variable diaphragm is moved to a large aperture position in which the f-number is one step smaller than the proper aperture setting. The exposure is started after the variable diaphragm is driven from the small aperture position to the large aperture position. The aperture diameter changes such that the exposure amount is approximately equal to the proper aperture setting. The image taking is completed when the variable diaphragm is driven to the large aperture position after the exposure.

### BACKGROUND OF THE INVENTION

1. Field of the Invention

The present invention relates to an image-taking apparatus and image-taking method for imaging an object outside depth of field with excellent blur effect.

2. Description of Background Arts

An image-taking method, which produces visual effect by utilizing the blur effect of a taking lens in taking an object outside depth of field of the taking lens, is known as one of the photographic techniques. Visual effects, which cannot be produced by focusing effect original to the taking lens, can be produced by, for instance, emphasizing a front view as a subject by blurring away the background or giving the fantastic expression by blurring a light source which illuminates a night scene.

A taking lens with excellent blur effect can produce a round-shaped image blur by diffusing an outline of the object with smooth gradation. However, the image blur in a taken image is largely influenced by a shape of a diaphragm such that a light source outside the depth of field (for instance, a streetlight in the background) blurs in nearly identical shape with the diaphragm. Therefore, a taking lens system of a high-grade camera incorporates an iris diaphragm, which is constituted of many diaphragm blades and forms an approximate circle aperture constantly.

However, the iris diaphragm incorporated in the high-grade camera requires many diaphragm blades in order to form the aperture in the shape of an approximate perfect circle. Further, a mechanism for precisely controlling positions of many diaphragm blades will increase the manufacture cost.

A diaphragm device disclosed in Japanese Patent Laid-Open Publication No. 7-199271 includes a fixed diaphragm forming a round aperture in which plural notches in the shape of the teeth of a comb are formed. An aperture ratio of the fixed diaphragm decreases toward the outside of the aperture, so that the outline of the object is formed more smoothly by rotating the fixed diaphragm during the exposure compared to ordinary round-shaped diaphragm.

However, the diaphragm device disclosed in Japanese Patent Laid-Open Publication Number 7-199271 needs to incorporate a mechanism for rotating the aperture in high speed for producing excellent blur effect. As a result, the diaphragm device is upsized.

### SUMMARY OF THE INVENTION

An object of the present invention is which an image taking apparatus and an image taking method, can exhibit excellent blur effect by diffusing an outline of an object favorably, in a simple configuration.

To achieve the above object, an image-taking apparatus, which takes an image of an object through a taking lens disposed on an optical axis, includes a diaphragm device, which forms an aperture on the optical axis, and a diaphragm drive section which changes an aperture size during an exposure of the image. The aperture size of the diaphragm device is variable.

The image-taking apparatus further includes a diaphragm control section connected to the diaphragm drive section for determining a proper aperture state for proper exposure amount and for defining a large aperture state, which has a larger aperture than the proper aperture state, and a small aperture state, which has a smaller aperture than the proper aperture state.

The diaphragm control section changes the aperture size during exposure in order to make an exposure light amount approximately equal to that when exposure is carried out at the proper aperture state.

The diaphragm control section changes the aperture size from the small aperture state to the large aperture state via the proper aperture state. Alternatively, it is also possible to change the aperture size from the large aperture state to the small aperture state via the proper aperture state.

According to the present invention, gradation changes smoothly to diffuse the outline by driving the variable diaphragm to change the aperture size during exposure. As a result, an excellent blur effect can be produced. Further, the above effect can be achieved in a simple configuration so that cost and size of a camera can be reduced.

### BRIEF DESCRIPTION OF THE DRAWINGS

The above objects and advantages of the present invention will become apparent from the following detailed descriptions of the preferred embodiments when read in association with the accompanying drawings, which are given by way of illustration only and thus do not limit the present invention. In the drawings, the same reference numerals designate like or corresponding parts throughout the several views, and wherein:

FIG. 1 is a front view of a perspective illustration of a digital camera;

FIG. 2 is a rear view of the perspective illustration of the digital camera;

FIG. 3 is a block diagram showing an electrical configuration of the digital camera;

FIGS. 4A and 4B are plan views showing configuration of a variable diaphragm;

FIG. 5 is a flow chart showing operational sequence of photographing; and

FIG. 6 is an explanatory view showing a change in aperture diameter during exposure.

### DETAILED DESCRIPTION OF THE EMBODIMENTS

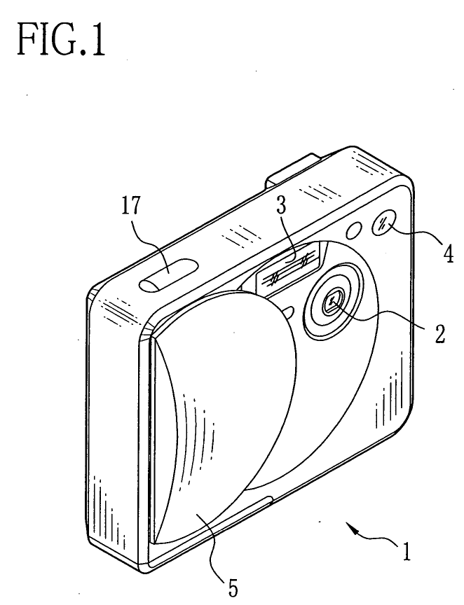

Referring to FIG. 1, a taking lens 2, a flash emission section 3, an optical viewfinder 4, and a protective cover 5 are provided on the front of a main body of a digital still camera 1. The protective cover 5 is slidable. When the protective cover 5 slides to cover the taking lens 2 and the flash emission section 3, a power supply is turned off. When the protective cover 5 slides to open, the taking lens 2 and the flash emission section 3 are exposed and the power supply is turned on for taking images.

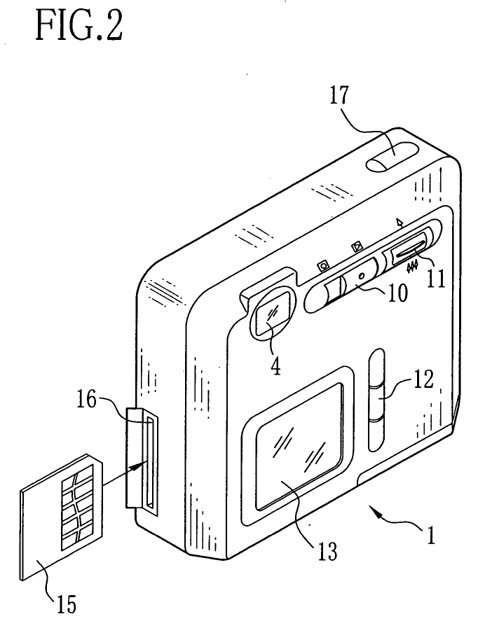

Referring to FIG. 2, a slide switch 10, which switches between a shooting mode and a playback mode, a zoom switch 11 for activating a digital zoom, and an operation key 12 are provided on the back of the digital still camera 1. An LCD monitor 13 displays a taken object image in full color.

A memory card 15 records image data of a taken object. The memory card 15 is removably inserted to the main body of the digital still camera 1 through a memory card slot 16 which is provided on the side of the digital still camera 1. A release button 17 is pressed in two steps operation: a half-pressing operation and a full-pressing operation. When the release button 17 is half-pressed in the shooting mode, metering and focusing are achieved. While keeping the release button 17 in a half-pressed state, the object image is recorded by fully pressing the release button 17.

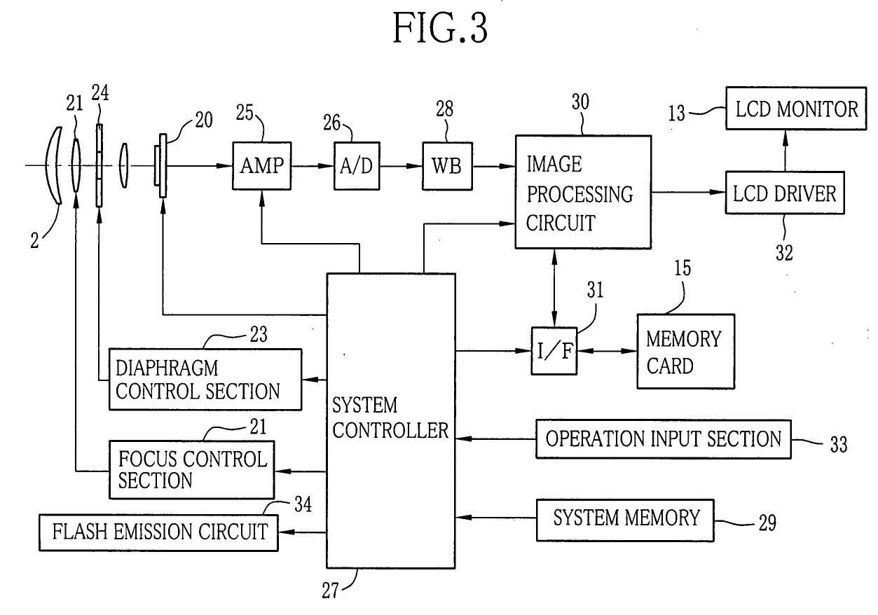

Referring to FIG. 3, a CCD image sensor 20 is provided behind the taking lens 2. The CCD image sensor 20 photoelectrically converts object light incident from the taking lens 2 to output an image signal corresponding to a taken object. When the release button 17 is half-pressed, a focus control section 21 drives a focus lens 22 to an optical axis direction to obtain focusing according to contrast of object light. A diaphragm control section 23 drives plural diaphragm blades, which form a variable diaphragm 24, in order to change an aperture diameter continuously.

The image signal output from the CCD image sensor 20 is amplified to an appropriate level in an amplifier 25, and digitally converted in an A/D converter 26. A system controller 27 controls gain of the amplifier 25. Sensitivity is determined according to the gain. A white balance correction circuit 28 amplifies the image signal of specific color component to correct white balance of the image according to a light source.

The system controller 27 controls operation of each part by executing a control program stored in a system memory 29. The digitally converted image signal is subject to image quality correcting processing such as gamma correction processing, and image compression/decompression processing based on JPEG standard, in an image processing circuit 30. A media interface 31 makes an access to the inserted memory card 15 to write image data into the memory card 15 and to retrieve stored image data from the memory card 15. The image signal is input from the image processing circuit 30 to an LCD driver 32 to display the taken object image in the LCD monitor 13.

An operation input section 33 generates an operation signal in response to each operation of the operation key 12 and the release button 17, and outputs the operation signal to the system controller 27. A flash emission circuit 34 is charged in response to the control signal, which is input from the system controller 27, in order to be ready for flashlight photography, and causes the flash emission section 3 to emit flashlight in synchronism with the exposure.

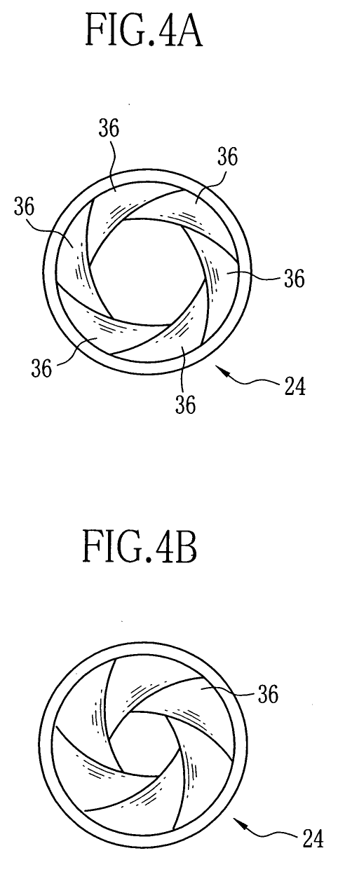

The system controller 27 calculates proper exposure according to the level of image signals output from the CCD image sensor 20. Thereafter, the aperture diameter is adjusted by actuating the diaphragm control section 23. Referring to FIG. 4A and FIG. 4B, the variable diaphragm 24 according to the embodiment includes six diaphragm blades 36. A shape of the variable diaphragm 24 is an approximate circle in full aperture (see FIG. 4A), and gradually turns into a hexagon as the aperture diameter becomes smaller (FIG. 4B). The diaphragm control section 23 drives the variable diaphragm 24 in order to form the aperture diameter according to a diaphragm drive signal which is input from the system controller 27.

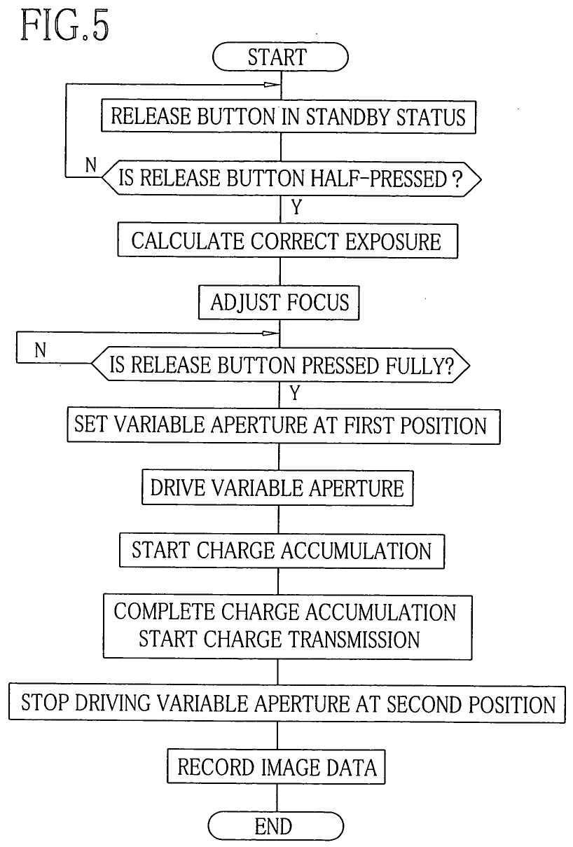

Referring to FIG. 5, operations of digital still camera 1 and the variable diaphragm 24 are described. The power supply is turned on after the memory card 15 is set in the digital still camera 1. Thereafter, the slide switch 10 is operated to set the shooting mode. The system controller 27 drives the CCD image sensor 20 to start taking the object image. The image signal, which is output from the CCD image sensor 20, is input to the image processing circuit 30 through the amplifier 25 and the A/D converter 26. The image signal is subject to image quality correction processing in the image processing circuit 30 and input to the LCD driver 32. The taken object image is displayed continuously in the LCD monitor 13.

When the release button 17 is half-pressed, metering and focusing are achieved. The system controller 27 calculates object brightness according to the gain, which is amplified by the amplifier 25, and determines the aperture diameter of the variable diaphragm 24 to achieve proper exposure amount. The system controller 27 outputs the diaphragm drive signal to the diaphragm control section 23 to drive the variable diaphragm 24 for forming a determined aperture diameter.

After the exposure is adjusted by driving the variable diaphragm 24, and focusing is achieved by driving the focus lens 22, the image is taken by pressing the release button 17 fully. The system controller 27 sends the diaphragm drive signal to the diaphragm control section 23. Thereby, the variable diaphragm 24 is set in a small aperture state in which an f-number is one step larger than that for proper exposure amount. The diaphragm control section 23 widens the aperture diameter of the variable diaphragm 24 gradually in order to drive the variable diaphragm 24 to a large aperture state in which the f-number is one step smaller than that for proper exposure amount.

The system controller 27 controls the operation of the CCD image sensor 20. The signal charges obtained by photoelectrically converting optical image of the object is accumulated and transmitted while the variable diaphragm 24 is driven from the small aperture state to the large aperture state.

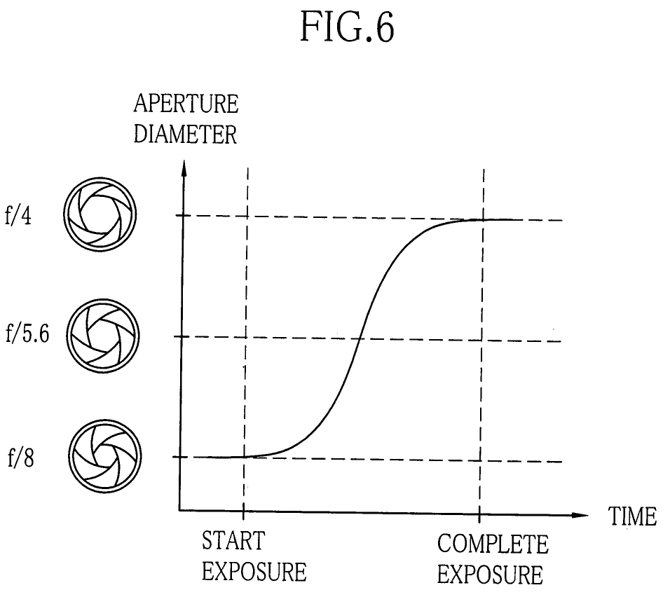

In an example shown in FIG. 6, a proper f-number for achieving proper exposure amount is determined to be f/5.6. An aperture position at f/8, which is one step larger than the proper f-number, is determined to be the small aperture state. An aperture position at f/4, which is one step smaller than the proper f-number, is determined to be the large aperture state.

First, the variable diaphragm 24 is set in the small aperture state. Then, in response to shutter release operation, accumulation of signal charges (that is, exposure) is started after or concurrently with driving the variable diaphragm 24 toward widening the aperture diameter.

The variable diaphragm 24 is driven to increase the aperture diameter toward the large aperture state via correct exposure state at f/5.6. The exposure is completed when the signal charges are discharged and transmitted concurrently with or before the large aperture state. It is possible to perform excellent blur effect by changing the aperture diameter of the variable diaphragm 24 to smoothly diffuse an outline of the object which is placed outside the depth of field.

Thus, the diaphragm control section 23 drives the variable diaphragm 24 to change the aperture diameter such that the exposure amount is approximately equal to that when the exposure is carried out with the proper aperture diameter (f/5.6). The image signal output from the CCD image sensor 20 is sent to the A/D converter 26 through the amplifier 25, and is subject to white balance correction. Thereafter, the image signal is subject to image quality correction and image compression in the image processing circuit 30 and is recorded in the memory card 15 as digital image data. The taken image can be checked by actuating the playback mode by operating the slide switch 10 to retrieve the image data from the memory card 15 and display the taken image on the LCD monitor.

In the above embodiment, the diaphragm blades of the variable diaphragm 24 are driven so as to change the aperture diameter smoothly. However, it is also possible to drive the diaphragm blades to change the aperture diameter linearly. Further, the exposure can be completed after keeping the aperture diameter in the small aperture state, the correct aperture state and the large aperture state, in sequence for a certain period of time respectively.

In the above embodiment, small/large aperture states are determined by increasing/decreasing the f-number by one step from that for the proper exposure amount. However, the small/large aperture states can be determined by increasing/decreasing the f-number by plural steps from that for proper exposure amount.

In the above embodiment, the variable diaphragm 24 is constituted of six diaphragm blades. However, the number of the diaphragm blades is not limited to six. Further, the aperture diameter can be changed by shifting an aperture plate formed with plural apertures of different sizes during the exposure.

In the above embodiment, the variable diaphragm 24 is driven to widen the aperture diameter. However, it is also possible to set the variable diaphragm 24 in the large aperture before the exposure, and narrow the aperture diameter during the exposure.

The present invention can be applied to any camera capable of recording still images, for instance, a lens-fitted photo film unit, in addition to the digital still camera. Further, the present invention can be applied to a camera capable of manual diaphragm adjustment. Furthermore, the present invention can be applied to a camera, which is formed integrally with a lens, or a camera capable of changing the lens.

Although the present invention has been described with respect to the preferred embodiment, the preset invention is not to be limited to the above embodiment but, on the contrary, various modifications will be possible to those skilled in the art without departing from the scope of claims appended hereto.

What is claimed is:

1. An image-taking apparatus for taking an image of an object through a taking lens disposed on an optical axis, said image-taking apparatus comprising:
a diaphragm device forming an aperture on said optical axis, wherein an aperture size of said diaphragm device is variable; and
a diaphragm drive section for changing said aperture size during an exposure of said image.

2. An image-taking apparatus as recited in claim 1, said image-taking apparatus further comprising:
a diaphragm control section connected to said diaphragm drive section for determining a proper aperture state for proper exposure amount and for defining a large aperture state having a larger aperture than said proper aperture state, and a small aperture state having a smaller aperture than said proper aperture state;
wherein said diaphragm control section changes said aperture size during exposure in order to make an exposure light amount approximately equal to that when exposure is carried out at said proper aperture state.

3. An image taking apparatus as recited in claim 2, wherein said diaphragm control section changes said aperture size from said small aperture state to said large aperture state via said proper aperture state.

4. An image taking apparatus as recited in claim 2, wherein said diaphragm control section changes said aperture size from said large aperture state to said small aperture state via said proper aperture state.

5. An image-taking method for taking an object through a taking lens disposed on an optical axis, said method comprising the steps of:
(a) determining an aperture size formed on said optical axis; and
(b) changing said aperture size during an exposure of said image.

6. An image-taking method as recited in claim 5, said method further comprising the steps of:
(c) determining said aperture size for proper exposure amount as a proper aperture state;
(d) defining a large aperture state which has larger aperture than said proper aperture state, and a small aperture state which has smaller aperture than said proper aperture state; and
(e) changing said aperture size during said exposure in order to make exposure light amount approximately equal to that when exposure is carried out at said proper aperture state.

7. An image-taking method as recited in claim 6, wherein said aperture size changes from said small aperture state to said large aperture state via said proper aperture state.

8. An image-taking method as recited in claim 6, wherein said aperture size changes from said large aperture state to said small aperture state via said proper aperture state.
